(19) United States
(12) Patent Application Publication
(10) Pub. No.: US 2020/0240656 A1
(43) Pub. Date: Jul. 30, 2020

(54) METHOD FOR MANUFACTURING AN AIR INTAKE DUCT

(71) Applicant: NOVARES France, CLAMART (FR)

(72) Inventors: Thomas JEAN, HOUDAIN (FR); Julien BRODNIK, LOISON SOUS LENS (FR)

(21) Appl. No.: 16/620,279

(22) PCT Filed: Apr. 25, 2018
(86) PCT No.: PCT/FR2018/051048

§ 371 Date: Dec. 6, 2019

(30) Foreign Application Priority Data
Jun. 9, 2017 (FR) 17/55189

(51) Int. Cl. F24F 7/04; B29C 45/14

(52) U.S. Cl. CPC F24F 7/04; B29C 45/14065; B29C 45/14622; B29K 2023/16; B29C 45/14786; B29K 2713/00; B29C 45/14795

(57) ABSTRACT

The invention relates to a method of manufacturing an air-intake duct (30) with induction noise and radiated noise attenuation that is intended to be connected to an internal combustion engine. The method comprises the steps of: —(a): providing a mould (1) comprising two moulding cavities (2), each cavity (2) having at least one groove (4) adapted for moulding a rib (32) and having at least two half-bores (5) adapted for moulding end sleeves (34-36), —(b): providing a core (8) adapted to be positioned between the cavities (2), for moulding an air-intake duct (30), —(c): positioning a tubular layer (9) of air-porous material on the core (8), —(d): positioning the core (8) with the tubular layer (9) between the moulding cavities (2), —(e): injecting a thermoplastic material into the, or each, groove (4) and into each half-bore (5) of each cavity (2), in order to overmould ribs (32) and end sleeves (34-36) onto the tubular layer (9) so as to form a duct (30).

### CROSS REFERENCE TO RELATED APPLICATIONS

This application is a National Stage of PCT Application No. PCT/FR2018/051048 filed on Apr. 25, 2018, which claims priority to French Patent Application No. 17/55189 filed on Jun. 9, 2017, the contents each of which are incorporated herein by reference thereto.

### TECHNICAL FIELD

The present invention concerns a method for manufacturing an air intake duct connected to an internal combustion engine and an air intake duct manufactured according to this method.

### BACKGROUND

It is known that internal combustion engines have a low-frequency acoustic component ranging from 30 Hz to 1 kHz. This acoustic component is generated by the periodic opening and closure of the valves, as well as by the resonances of the different cavities of the engine (combustion chambers, ducts, . . . ). The low-frequency acoustic component propagates and radiates at the inlet of the air supply circuit of the engine. While propagating inside the air supply ducts of the engine, the low-frequency acoustic component excites the resonance of the ducts, which generates high acoustic emissions.

Furthermore, in the case of turbocharged engines, there is a high-frequency acoustic component ranging from 1 kHz to 15 kHz. This acoustic component is generated by the turbocharger and can also propagate and radiate through the air supply ducts.

Traditionally, mouth noise refers to the acoustic component that propagates in the air supply ducts, and radiated noise refers to the acoustic component radiated by the air supply ducts, themselves.

Currently, to attenuate the noises originating from the air intake ducts, it is known to use a muffler. A muffler usually has a central tube in which air circulates, and whose wall is perforated with several orifices which puts the inside of the tube in communication with a peripheral chamber, delimited by a bell which surrounds the central tube. When stimulated by sound waves, the small volume of air contained in each orifice acts substantially as a small mass, which would be suspended from a spring constituted by the larger volume of air contained in the peripheral chamber. An attenuation of the noise is thus obtained in a spectral band located near the characteristic frequency of this <<mass-spring>> system.

However, the muffler does not allow covering the entire frequency range. Indeed, the muffler does not have a sufficient level of attenuation in the low-frequency field.

Another solution is to use a resonator. The resonator comprises a central tube having a closed bypass at a right angle. This type of resonator is very selective and works only over a very thin frequency band.

To improve the acoustic characteristics of the air intake duct, it is also known to add a porous medium that enhances the acoustic performance. In this regards, the document FR 2788833, filed by the applicant proposes a duct over a portion of which is overmolded a porous medium. Another known solution consists in welding two half-shells, produced by thermoforming, of a porous polyester medium. Mention may also be made to the document JP 2008063970 in which a porous hose is made with two half-shells in a thermos-compressed porous medium. The two half-shells are assembled by an attached clipping system. The implementation of these different techniques requires the use of an expensive tooling, such as an injection mold including a robotic system, to set up the porous medium in the mold. In addition, these techniques do not allow making a 100% porous pipe because of the technical constraints of manufacture.

Another known technique of the document EP 0665404 consists in winding a porous medium around a metallic structure. This technique requires the use of a special filament winding machine, this type of machine being very expensive.

### BRIEF SUMMARY

Consequently, the present invention aims at providing a simple and inexpensive method for manufacturing an air intake duct which has a maximum surface area of porous material.

According to a general definition, the invention concerns a method for manufacturing a duct for air intake and for attenuating mouth noises and radiated noises intended to be connected to an internal combustion engine. The method comprises the steps of:
(a): providing a mold comprising two molding cavities, each cavity having at least one groove adapted to mold a rib and having at least two half-bores adapted to mold end sleeves,
(b): providing a core adapted to be positioned between the cavities, for molding an air intake duct,
(c): positioning on the core a tubular sheet made of an air-porous material,
(d): positioning between the molding cavities the core with the tubular sheet,
(e) injecting into the, or each, groove and into each half-bore of each cavity a thermoplastic material, for overmolding ribs and end sleeves on the tubular sheet, in order to form a duct.

In a particularly advantageous manner, the method according to the invention allows manufacturing, in one single injection phase, an air intake duct having a maximum surface area of porous material. In other words, the method according to the invention allows manufacturing an air intake duct having a maximum surface area of porous material, with a reduced number of manufacturing steps. Thus, the invention proposes a simple and inexpensive method for manufacturing an air intake duct which has a maximum surface area of porous material.

According to a particular arrangement, the method may comprise a step (f) of forcibly removing the molded duct, by pulsed air.

According to a first embodiment, step (a) may comprise the provision of two molding cavities in which the grooves are adapted to mold a helical rib.

According to a second embodiment, step (a) comprises the provision of two molding cavities in which the grooves are adapted to mold several ribs forming a grid.

According to a particular arrangement, step (e) may comprise the injection of a thermoplastic elastomer material.

The invention also concerns a duct for air intake and for attenuating mouth noises and radiated noises intended to be connected to an internal combustion engine. The duct comprises a tubular sheet made of an air-porous material on which are overmolded at least one rib made of a thermoplastic elastomer material and two end sleeves made of a thermoplastic material, a first sleeve being intended to be connected to an internal combustion engine and a second sleeve being intended to be connected to an air intake circuit.

Thus, the duct according to the invention has a maximum surface area of porous medium, allowing attenuating the mouth noises and the radiated noises. In addition, the structure of the air intake duct according to the invention makes it light, thus allowing for a weight saving when the duct is installed in a vehicle. Furthermore, the overmolded ribs allow ensuring the resistance of the duct to the depression forces caused by the suction of air into the duct when the latter is connected to an internal combustion engine and to an air intake circuit.

According to a first embodiment, the duct may comprise a helical rib.

The helical rib may enable the duct to be flexible.

According to a second embodiment, the duct may comprise several ribs forming a grid.

According to a particular arrangement, the tubular sheet may have a porosity comprised between 200 l/m²/s and 600 l/m²/s under a pressure drop of 200 Pascals.

According to a particular arrangement, the thermoplastic material may be a thermoplastic elastomer material.

### BRIEF DESCRIPTION OF THE DRAWINGS

Other features and advantages of the present invention will emerge come out clearly from the detailed description hereinafter of two embodiments of the invention provided as non-limiting examples, with reference to the appended drawings in which:

FIG. 1 represents a mold in the open position and a core, according to the invention,

FIG. 2 represents the positioning on the core of a tubular sheet according to the invention,

FIG. 3 represents the closure of the mold, according to the invention,

FIG. 4 is a view in transparency of a closed mold, before the injection of a thermoplastic elastomer material,

FIG. 5 is a view in transparency of a closed mold, during the injection of a thermoplastic elastomer material,

FIG. 6 is a representation of the opening of the mold after injection,

FIG. 7 is a representation of the ejection of the molded air intake duct,

FIG. 8 is a representation of an air intake duct according to a first embodiment of the invention,

FIG. 9 is a representation of an air intake duct according to a second embodiment.

### DETAILED DESCRIPTION

The invention concerns a method for manufacturing a duct for air intake and for attenuating mouth noises and radiated noises intended to be connected to an internal combustion engine.

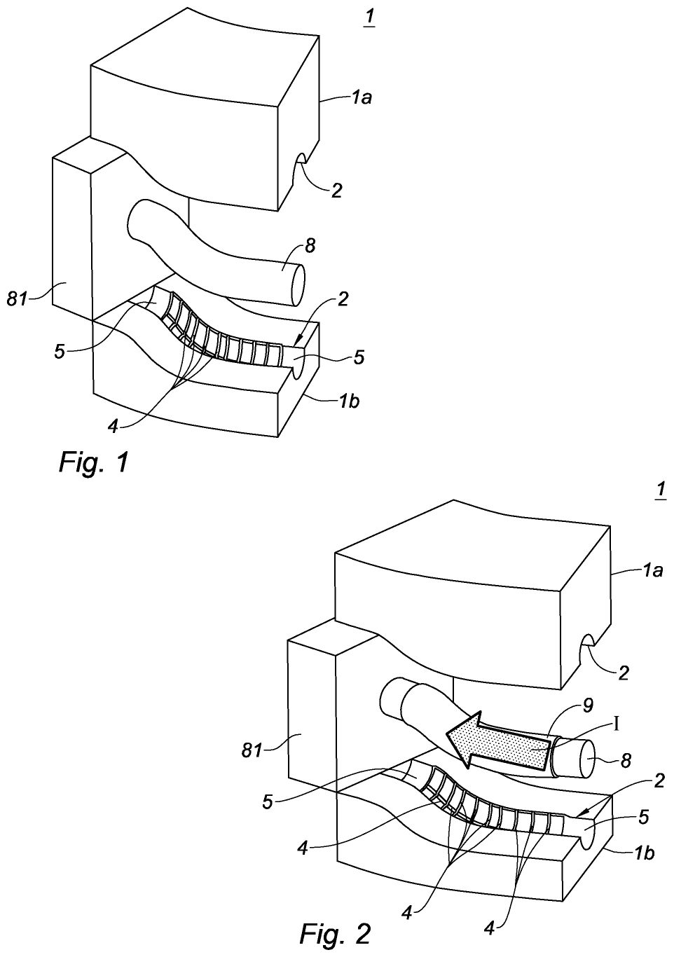

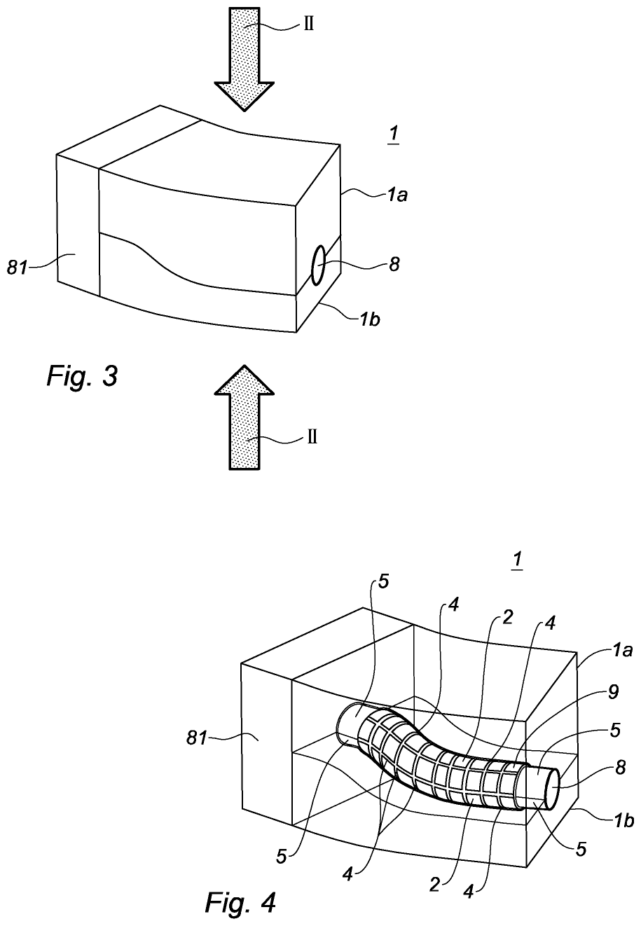

The method according to the invention can be implemented with a mold 1 shown in FIGS. 1 to 7. The mold 1 is intended to be installed in an injection molding press. According to the embodiment presented herein, the mold 1 comprises a first shell 1a and a second shell 1b. The two shells 1a and 1b are configured to be pressed against each other during the injection of a material into the mold, and to be spaced apart from each other after the injection operation. In a traditional manner, the first shell 1a is movable and the second shell 1b is fixed, relative to an injection molding press. Thus, the mold 1 is movable between an open position in which the two shells 1a and 1b are spaced apart from each other and a closed position in which the two shells 1a and 1b are pressed against each other. In a conventional manner, the mold 1 may be made of metal. Each shell 1a-1b has a cavity 2. According to the example presented herein, each cavity 2 has a substantially semi-cylindrical shape having a longitudinal curvature and two ends. Each cavity 2 has several grooves 4 and two half-bores 5. The two half-bores 5 are positioned at the ends of the cavity 2. In use condition, the grooves 4 allow molding one or several rib(s) 32 of a duct 30. Similarly, in use condition, the two half-bores 5 allow molding end sleeves 34-36 of the duct 30.

According to a first embodiment, the grooves 4 are adapted to mold a helical rib 32.

According to a second embodiment, the grooves 4 are adapted to mold several ribs 32 forming a grid.

Furthermore, according to an embodiment not represented, each cavity 2 may also have elements allowing molding, for example, fastening systems such as support legs, and systems for hooking other elements such as cables or other ducts.

The method according to the invention also uses a core 8 adapted to cooperate with the mold 1. In a known manner, in the field of injection molding, a core allows forming a hollow portion of a part or providing for an opening. In the method according to the invention, the core 8 allows providing for the hollow section of the duct 30. The core 8 can be made of metal. The core 8 is adapted to be positioned between the cavities 2. According to the example presented herein, the core 8 has a substantially cylindrical shape with a longitudinal curvature. According to the embodiment presented herein, the core 8 is fastened to a base 81 adapted to be pressed against the two shells 1a and 1b of the mold 1 in the closed position.

The mold 1 and the core 8 allow implementing the method for manufacturing an air intake duct 30 according to the invention. In addition to a step a of providing the mold 1 and a step b of providing the core 8, the method comprises a step c of positioning on the core 8 a tubular sheet 9. It is specified that by tubular sheet 9 is meant a sheet having two joined edges to substantially form a cylinder with a circular base. The two joined edges of the sheet may be welded, glued or sewn. Referring to FIG. 2, the tubular sheet 9 is fitted on the core 8 according to the direction of the arrow I. The tubular sheet 9 may, for example, be made of woven or non-woven material which may comprise several components. The tubular sheet 9 may have a porosity comprised between 200 l/m²/s and 600 l/m²/s under a pressure drop of 200 Pascals.

According to a particular arrangement, the tubular sheet 9 may be made from a non-woven material, produced by needling, comprising polyester fibers and bi-component fibers. The bi-component fibers may comprise a core made of polyester and a skin made of copolyester.

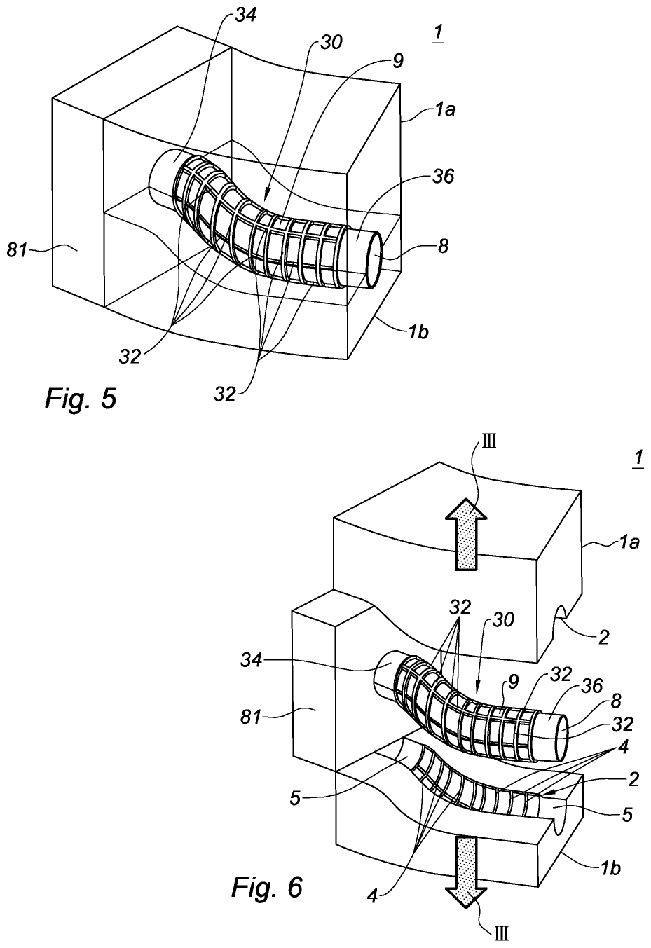

Afterwards, the method comprises a step d of positioning the core 8 between the cavities 2 of the mold 1 in the open position. Then, as represented in FIG. 3, the mold 1 is according to the directions of the arrows II. During the passage in the closed position, the bearing of the base 81 against the shells 1a and 1b may serve as a reference to ensure the correct positioning of the core 8 between the cavities 2. Referring to FIG. 5, the method has afterwards a step e of injecting into each groove 4 and into each half-bore 5, of each cavity 2 a thermoplastic elastomer material, to overmold ribs 32 and end sleeves 34 on the tubular sheet 9. This step allows molding the duct 30 in one single injection. In a particularly advantageous manner, during the injection into the grooves 4, the thermoplastic elastomer material penetrates locally into the tubular sheet 9, which allows ensuring the cohesion of the tubular sheet 9 with the, or each, rib 32 overmolded on the tubular sheet 9. According to a particular arrangement, the thermoplastic elastomer material may be of the ethylene-propylene-diene monomer type mixed with polypropylene. The overmolding of the ribs 32 on the tubular sheet 9 allows manufacturing a duct 30 having a maximum surface area of porous tubular sheet, while having optimum resistance to depression.

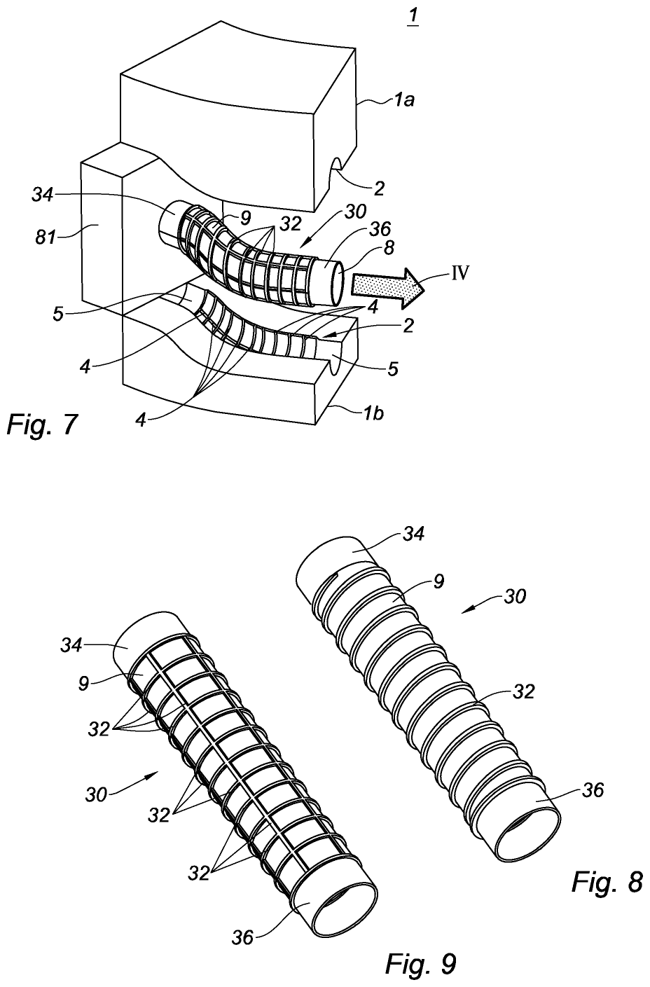

Referring to FIG. 6, the mold 1 is opened afterwards according to the directions of the arrows III, to allow recovery of the duct 30. According to a particular arrangement, the method may comprise a step f of forcibly removing the molded duct 30, by pulsed air (FIG. 7), according to the direction of the arrow IV.

Thus, the method according to the invention allows manufacturing the duct 30 in one single injection operation. The overmolding of the ribs 32 and the end sleeves 34 on the tubular sheet 9 allows ensuring the cohesion of the duct 30. In other words, the method according to the invention allows manufacturing the duct 30 in one single injection operation without the need to add operations of gluing, clipping or reworking of the different constituents of the duct 30.

The invention also concerns a duct 30 for air intake and for attenuating mouth noises and radiated noises intended to be connected to an internal combustion engine. The duct 30 comprises a tubular sheet 9 made of an air-porous material on which are overmolded one or several ribs 32 made of a thermoplastic elastomer material and two end sleeves 34-36 made of a thermoplastic elastomer material.

The tubular sheet 9 may have a porosity comprised between 200 l/m²/s and 600 l/m²/s. Such a porosity allows for an optimum attenuation of mouth noises and radiated noises.

According to a first embodiment, represented in FIG. 8, the duct 30 comprises a helical rib 32. The helical rib 32 may enable the duct 30 to be flexible.

According to a second embodiment, represented in FIG. 9, the duct 30 comprises several ribs 32 forming a grid.

In use condition, a first sleeve 34 is connected to an internal combustion engine and a second sleeve 36 is connected to an air intake circuit. In addition, the rib(s) 32 allow ensuring the resistance of the duct 30 to the depression caused by air suction. The tubular sheet 9, made of a porous material, allows achieving an acoustic impedance break or an adaptation, which allows avoiding the excitation of certain duct modes. Thus, the tubular sheet 9 allows reducing the mouth noises. In addition, because of the porosity of the material of the tubular sheet 9, the tubular sheet 9 allows diffusing a portion of the acoustic energy. The presence of a porous material over almost the entire periphery of the duct 30 allows distributing the radiated energy in an optimum manner, and thus reducing the radiated noises.

Of course, the invention is not limited to the embodiments described hereinabove and illustrated by the different figures, these embodiments having been provided only as examples. Modifications are still possible, in particular with regards to the constitution of the various elements or by the substitution of technical equivalents, yet without departing from the scope of the invention.

1. A method for manufacturing a duct for air intake and for attenuating mouth noises and radiated noises intended to be connected to an internal combustion engine, wherein it comprises the steps of:
(a): providing a mold comprising two molding cavities, each cavity having at least one groove adapted to mold a rib and having at least two half-bores adapted to mold end sleeves,
(b): providing a core adapted to be positioned between the cavities, for molding an air intake duct,
(c): positioning on the core a tubular sheet made of an air-porous material,
(d): positioning between the molding cavities the core with the tubular sheet,
(e) injecting into the, or each, groove and into each half-bore of each cavity a thermoplastic material, for overmolding ribs and end sleeves on the tubular sheet, in order to form a duct.

2. The manufacturing method according to claim 1, wherein the method further comprises a step (f) of forcibly removing the molded duct by pulsed air.

3. The manufacturing method according to claim 1, wherein step (a) comprises the provision of two molding cavities in which the grooves are adapted to mold a helical rib.

4. The manufacturing method according to claim 1, wherein step (a) comprises the provision of two molding cavities in which the grooves are adapted to mold several ribs forming a grid.

5. The manufacturing method according to claim 1, wherein step (e) comprises the injection of a thermoplastic elastomer material.

6. A duct for air intake and for attenuating mouth noises and radiated noises intended to be connected to an internal combustion engine, wherein the duct comprises a tubular sheet made of an air-porous material on which are overmolded at least one rib made of a thermoplastic material and two end sleeves made of a thermoplastic elastomer material, a first sleeve being intended to be connected to an internal combustion engine and a second sleeve being intended to be connected to an air intake circuit.

7. The duct according to claim 6, the duct comprises a helical rib.

8. The duct according to claim 6, wherein the duct comprises several ribs forming a grid.

9. The duct according to claim 6, wherein the tubular sheet has a porosity comprised between 200 l/m²/s and 600 l/m²/s under a pressure drop of 200 Pascals.

10. The duct according to claim 6, wherein the thermoplastic material is a thermoplastic elastomer material.

11. The duct according to claim 7, wherein the tubular sheet has a porosity comprised between 200 l/m²/s and 600 l/m²/s under a pressure drop of 200 Pascals.

12. The duct according to claim 11, wherein the thermoplastic material is a thermoplastic elastomer material.

13. The duct according to claim 8, wherein the tubular sheet has a porosity comprised between 200 l/m²/s and 600 l/m²/s under a pressure drop of 200 Pascals.

14. The duct according to claim 13, wherein the thermoplastic material is a thermoplastic elastomer material.

15. The manufacturing method according to claim 2, wherein step (a) comprises the provision of two molding cavities in which the grooves are adapted to mold a helical rib.

16. The manufacturing method according to claim 2, wherein step (a) comprises the provision of two molding cavities in which the grooves are adapted to mold several ribs forming a grid.

17. The manufacturing method according to claim 2, wherein step (e) comprises the injection of a thermoplastic elastomer material.

18. The manufacturing method according to claim 15, wherein step (e) comprises the injection of a thermoplastic elastomer material.

19. The manufacturing method according to claim 16, wherein step (e) comprises the injection of a thermoplastic elastomer material.
